(19) United States
(12) Patent Application Publication
(10) Pub. No.: US 2006/0058954 A1
(43) Pub. Date: Mar. 16, 2006

(54) Constrained tracking of ground objects using regional measurements

(76) Inventor: Philip J Haney, MERRIMACK, NH (US)

Correspondence Address: MAINE & ASMUS, P. O. BOX 3445, NASHUA, NH, 03061, US

(21) Appl. No.: 10/530,392

(22) PCT Filed: Oct. 4, 2004
(86) PCT No.: PCT/US04/32706

§ 371 Date: Apr. 6, 2005

Related U.S. Application Data
(60) Provisional application No. 60/509,835, filed on Oct. 8, 2003.
(60) Provisional application No. 60/604,224, filed on Aug. 24, 2004.

(51) Int. Cl. G01C 21/30

(52) U.S. Cl. 701/209

(57) ABSTRACT

A method for constrained tracking of objects using regional measurement. In one embodiment the system includes a plurality of sensors deployed in a region, wherein the sensors detect a mobile target. A first processing section receives target data from the sensors and processes target localization information. A second processing section linearly constrains the target localization information and generates a regional measurement which is filtered to generate an accurate target location.

### RELATED APPLICATIONS

This application claims the benefit of U.S. Provisional Application No. 60/509,835 filed Oct. 8, 2003, and U.S. Provisional Application 60/604,224 filed Aug. 24, 2004, both of these applications are herein incorporated in their entirety by reference.

### STATEMENT OF GOVERNMENT INTEREST

Portions of the present invention may have been made in conjunction with Government funding under contract number N66001-98-C8515 and there may be certain rights to the Government.

### FIELD OF THE INVENTION

The invention relates to tracking of objects, and more particularly, to a system of tracking targets using constrained tracking.

### BACKGROUND OF THE INVENTION

There are numerous fields and applications related to tracking of targets and the estimation of position/location of the targets at some future time based on mathematical equations. For example, Kalman filtering is an efficient computational (recursive) means to estimate the state of a process, in a way that minimizes the mean of the squared error and is very beneficial in that it supports estimations of past, present, and even future states, and it can do so even when the precise nature of the modeled system is unknown.

One of the applications is the detection of targets based on one or more sensors that attempts to locate an approximate position of a target at some instant of time and track that target as it moves. Future position estimates are calculated using certain a-priori information. There are many variables that contribute to the overall calculations, and the state of art is always attempting to refine the estimation process.

There are numerous types of sensors in the security, defense and military implementations. Distributed unattended ground sensor (UGS) systems are used to meet a wide variety of program requirements related to the precision tracking of ground vehicles, persons/animals and other objects. The UGS sensors are inexpensive electronic devices that are deployed in areas in which the detection of moving objects is desired. The sensor technology comes in many forms including acoustics, electrostatic, magnetic, optics, seismic, and imaging. There are numerous detection modules that are known to those skilled in the art that can be co-located with the UGS providing sensing and detection capability employing one or more detection types.

The UGS typically has a power source, one or more sensors, and a communications section that are coupled together within an inexpensive form factor. Some sensors even incorporate a processing section. These small units can be manually deployed or deployed by other means such as artillery and air deployment.

The UGS units typically are low power devices and therefore have a limited range for detection as well as transmission. A plurality of UGS's can create a network of detection devices that can communicate with each other and with a central location for processing data from all such sensors. Using an array of sensors can more accurately identify the location of a target and develop a grid for detection and tracking. The micro-internetted unattended ground sensors (MIUGS) are examples of networking within a community of deployed sensors.

A technique that is often used to assist in achieving high-precision tracking of object such as ground vehicles is referred to as constrained tracking. Constrained tracking is a procedure which utilizes a-priori information based upon the likelihood that an object is traveling along a given path. There are a number of methods for performing constrained tracking of vehicles which are known to those skilled in the art, and rely on confining a tracking filter's state estimates based upon some usage of a-priori road information. If the likelihood of a vehicle traveling along a given path is high, then information related to the known path can be used to assist in achieving improved tracking accuracies.

Thus, typical methods for performing constrained tracking rely on constraining the state estimate outputs of a tracking filter to a-priori road information. However, such methods often induce an adverse effect into the closed-loop nature of the tracking filter's algorithm which results in degraded tracking performance when large spatial and/or dynamic constraints are required.

There have been numerous efforts in various fields that have made progress to suit the particulars of a specified application. For example, studies in automatic vehicle location (AVL) utilize processing techniques that track vehicle, such as trucks. One implementation uses a communications link from the vehicle to a central processing center establishes a perimeter about the truck in which the truck is supposed to travel. The concept of geo-fencing checks for anomalies that could indicate truck problems or other unexpected difficulties if the truck position breaches the established perimeter.

Unfortunately, the track constrained methods often induce an adverse effect into the closed-loop nature of the tracking filter's algorithm which results in degraded tracking performance when large spatial and/or dynamic constraints are required. What is needed is a method for performing constrained tracking which constrains the open-loop measurements supplied to the tracking filter. By constraining the open-loop measurement data prior to being applied to the tracking filter, the closed-loop algorithm structure of the tracking filter remains unaltered and the constrained tracking performance may be more responsive and robust.

### BRIEF SUMMARY OF THE INVENTION

One embodiment of the present invention provides a measurement-constrained approach to performing constrained tracking. By constraining the open-loop measurement data prior to being applied to the estimator, the closed-loop nature of the estimator remains unaltered and the tracking performance is shown to be more responsive and robust. Thus, adverse closed-loop effects observed when constraining target track state estimate data to a-priori road information are eliminated. Such closed-loop effects are eliminated by constraining open-loop measurement information and applying constrained measurements to target tracking filter thus leaving closed-loop algorithm structure of tracking filter unaltered.

One embodiment is a method for tracking mobile objects along a target path, comprising identifying a plurality of way-points along the target path and processing a position measurement of at least one object. Another step includes computing a distance parameter between the position measurement and at least two of the way-points, and defining a road segment between two of the way points that are closest to the position measurement. Linearly constraining the measurement position to the road segment and computing a regional measurement.

The method can further comprise determining a likelihood that the position measurement is within a range of the target path, and computing the position measurement without linearly constraining if the position measurement is outside the range. The range can be fixed or a statistical distance such as a chi-square threshold.

The way-points are position coordinates and can be selected from at least one of the group consisting of: pre-determined geographical positions and dynamically derived geographical positions.

The position measurement can be derived from triangulating a set of bearing lines from at least two sensors. The position measurement can also be transmitted from a repeater that relays the position measurement.

There are typically a number of variables, and the computing can employ at least one uncertainty variable, wherein the uncertainty variable is selected from at least one of the group consisting of a set of road way-point uncertainties and a measurement covariance.

Other steps in the method may include applying the regional measurement to a tracking filter. Various filters can be used, and this includes the tracking filter being a constant gain and variable gain filter, including a Kalman filter.

A further embodiment includes an apparatus for tracking at least one mobile target, comprising a communications section, a memory device, and a microprocessor coupled to the communications section and the memory device. The microprocessor comprises a constrained measurement unit, and an estimator, wherein a target position measurement is linearly constrained by the constrained measurement unit prior to processing by the estimator. The estimator can be any of the filter types known to those skilled in the art, such as a Kalman filter. The microprocessor can further comprise a fusion section that processes the target position measurement from a set of sensor measurements received by the communications section. The system can also have a global positioning system (GPS) coupled to the microprocessor.

Another embodiment includes a system for tracking at least one mobile target in a region along a target path having way-points, comprising a plurality of sensors deployed in the region, wherein the sensors detect the mobile target. A first processing section receives target data from the sensors and processes target localization information. A second processing section is used, wherein the target localization information is linearly constrained and generates a regional measurement. A third processing section filters the regional measurement and generates a filtered target position. The third processing section can include a filter such as a variable gain or constant gain filter. The filtered target position can be used to update a target track

The target data from the sensors can be at least two bearing lines and the target localization information and is processed using triangulation from the bearing lines.

The target path can have threshold bounds and if the target localization information is outside the threshold bounds, the target localization information is not linearly constrained and the target localization information establishes a non-constrained target position.

The first processing section can also receive target data from at least one repeater unit that communicate with the sensors. The filtered target position may be communicated to a central processing center.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIG. 1 is a diagrammatic perspective showing a plurality of sensors deployed about a target traveling along a given path.

FIG. 2 is a flow chart diagram illustrating directional process noise (track-constrained approach).

FIG. 3 is a flow chart diagram illustrating pseudo-measurements (track-constrained approach).

FIG. 4 is a flow chart diagram illustrating one embodiment for regional measurements (measurement-constrained approach).

FIG. 5 shows the target path and node configuration used for field-tests.

FIG. 6a illustrates test data for the spatial tracking performance for baseline method of constrained tracking.

FIG. 6b illustrates test data for the spatial tracking performance for directional process noise method of constrained tracking.

FIG. 6c illustrates test data for the spatial tracking performance for pseudo-measurements of constrained tracking.

FIG. 6d illustrates test data for the spatial tracking performance for regional measurement of constrained tracking.

FIG. 7a illustrates the track error to truth for baseline method of constrained tracking.

FIG. 7b illustrates the track error to truth for directional process noise method of constrained tracking.

FIG. 7c illustrates the track error to truth for pseudo-measurement method of constrained tracking.

FIG. 7d illustrates the track error to truth for regional measurement method of constrained tracking.

FIG. 8a graphically illustrates the directional process noise model.

FIG. 8b graphically illustrates the pseudo-measurements model.

FIG. 8c graphically illustrates the regional measurements model.

FIG. 9 is a block diagrammatic perspective of central command and control.

FIG. 10 is a system flow chart for the regional constrained measurement system.

### DETAILED DESCRIPTIONS OF THE INVENTION

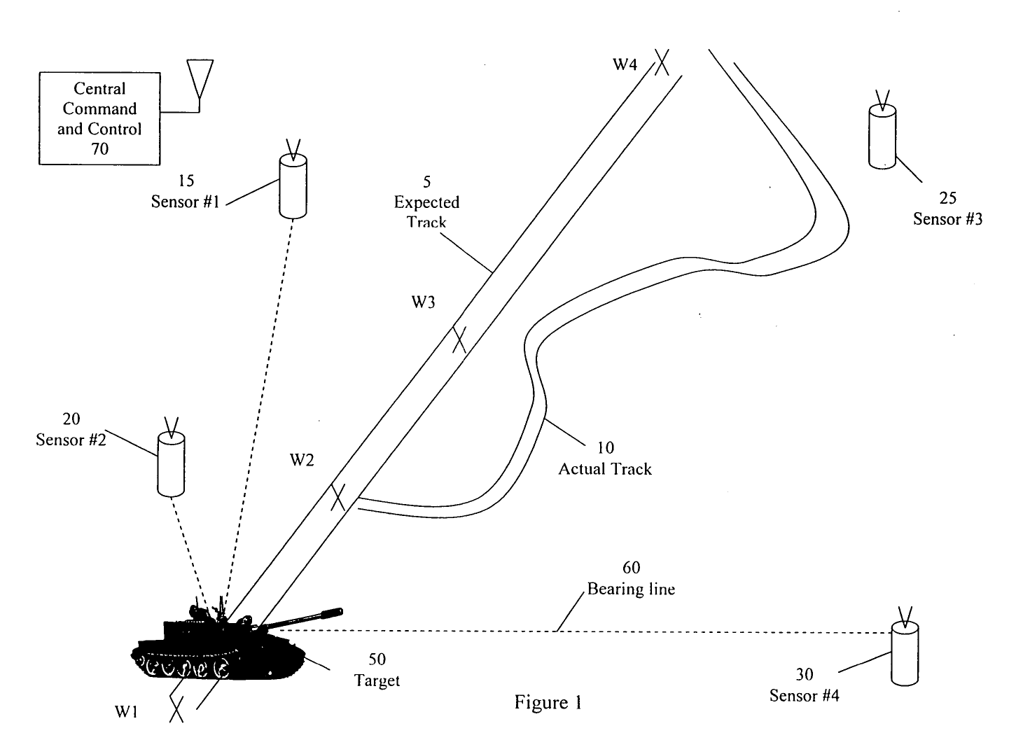

Referring to FIG. 1, a plurality of sensors 15, 20, 25, 30 are deployed in a given region that indicates a road or expected track 5 as well as the actual path or track 10 that is taken by a target 50. There are a number of way-points W1, W2, W3, and W4 along the expected path 5 that are pre-determined position points. Waypoints are geographical coordinates or locations used for positioning that can be previously recorded and stored in the UGS or at the central command 70. They may be check points on a route, significant ground features, data from other UGS units, or a fully mapped region that allows for dynamic allocation of the waypoints. These way-points W1-W4 may be stored in memory within the central command 70 or the sensors 15, 20, 25, 30 and may also be downloaded or updated to the units.

At any given time, one or more sensors 15, 20, 25, 30 may be able to detect the presence of the target vehicle 50 and provide some bearing or location data. The UGS units 15, 20, 25, 30 may have processing capability to compute the constrained tracking computations or transmit data to a central command and control processing center 70. In a typical scenario, several sensors establish a bearing line 60 from the sensor to the target. Each of the bearing lines 60 are communicated to the central command or gateway 70 which uses the bearing lines to triangulate a target position. A repeater (not shown) can relay the sensor data from the low-powered sensors to other sensors, gateways or central command to extend the geographic coverage.

There may be periods that the sensors 15, 20, 25, 30 may not detect the target 50 due to location of the target 50 or if the target otherwise become undetectable. The UGS units 15, 20, 25, 30 may also be intermittent in operation in relation to detection or transmission. In any event, there may be periods where the target 50 location is unknown and estimates are required for present and future locations.

The present application describes three methods for performing constrained tracking:
1. Directional Process Noise (track-constrained approach)
2. Pseudo-Measurements (track-constrained approach)
3. Regional Measurements (measurement-constrained approach)

Each of the three methods assume that some a-priori road information (way-points) have been collected prior to implementation. As described herein, the simulation results illustrate that the measurement-constrained approach is more responsive and robust then the track-constrained approaches.

Directional Process Noise

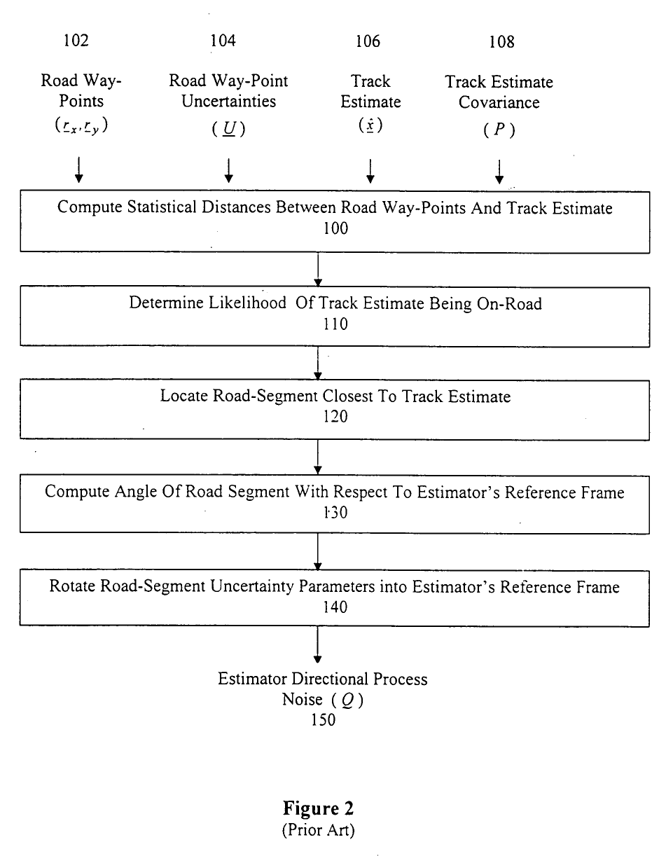

“Directional process noise” is a method of performing constrained tracking which computes angular information between road way-points and adjusts the estimator's process noise to allow for more bandwidth along the expected direction of target motion and less bandwidth orthogonal to the expected direction of target motion. A flow diagram for the “directional process noise” method is provided in FIG. 2.

The typical track-constrained approaches rely on constraining the state estimate outputs of a tracking filter to a-priori road information. These methods tend to induce adverse effects into the closed-loop nature of the estimator resulting in degraded tracking performance when large spatial and/or dynamic constraints are required. Road way-points are typically measured using some global position system (GPS) and stored in memory locally or communicated as required.

The algorithm descriptions corresponding to each element in FIG. 2 are provided herein. The first step 100 is the computing the statistical distance between road way-points and track estimates. Certain information is required for the processing, namely road-way points 102, road way-point uncertainties 104, track estimate 106 and track estimate covariance. The road elements 102, road element uncertainties 104, track estimate 106 and track estimate covariance 108 are processed in order to compute the normalized distance parameters.

The processing commences as follows:
Compute Statistical Distances Between Road Way-Points and Track Estimate 100:

$$\begin{matrix}{D}_{i} = {{v}_{i}}^{′} {S}_{i}^{- 1} {v}_{i} \\ \text{for} i = 1 , 2 , … , N \\ \underline{\text{where}} ∷ N = \text{number of road way-points} \\ {v}_{i} = [ \begin{matrix}{rx}_{i} - \hat{x} \\ {ry}_{i} - \hat{y}\end{matrix} ] \\ {S}_{i} = [ {HPH}^{′} + {U}_{i} ] \\ H = observation matrix\end{matrix}$$

The track-to-road processing computes the normalized distance parameters between each road way-point and the desired track. Determine Likelihood Of Track Estimate Being On-Road 110:
Dₘᵢₙ_{₁}<χ₂²
Dₘᵢₙ_{₂}<χ₂²
where:
   Dₘᵢₙ_{₁}=first minimum statistical distance
   Dₘᵢₙ_{₂}=second minimum statistical distance
   χ₂²=chi-square threshold for two degrees of freedom

A road segment is defined based upon the two closest road way-points to the desired track. The next step defines the road segment based upon minimum distance parameters. The processing commences as follows:

Locate Road-Segment Closest to Track Estimate 120:
Rx₁=r_{xDmin}_{₁}
Ry₁=r_{yDmin}_{₁}
Rx₂=r_{xDmin}_{₂}
Ry₂=r_{yDmin}_{₂}
where:
   Rx₁, Ry₁=way-point corresponding to first minimum statistical distance.
   Rx₂, Ry₂=way-point corresponding to second minimum statistical distance.

The next step computes the road segment orientation angle. Compute Angle Of Road-Segment With Respect to the estimator's reference frame 130:

$$ψ = {tan}^{- 1} ( \frac{{Rx}_{1} - {Rx}_{2}}{{Ry}_{1} - {Ry}_{2}} )$$

It is then necessary to Rotate Road Segment Uncertainty Parameters Into Estimator's Reference Frame 140 and compute the directional process noise 150:

$$Q = [ \begin{matrix}- cos ( ψ ) & sin ( ψ ) \\ sin ( ψ ) & cos ( ψ )\end{matrix} ] [ \begin{matrix}{σ}_{o}^{2} & 0 \\ 0 & {σ}_{a}^{2}\end{matrix} ] [ \begin{matrix}- cos ( ψ ) & sin ( ψ ) \\ sin ( ψ ) & cos ( ψ )\end{matrix} ]$$

where:
   σ₀²=expected process noise variance orthogonal to road-segment
      σₐ²=expected process noise variance along road-segment

The Kalman filter process noise for the desired track is directionalized along the road segment. For example, the filter bandwidth along the associated road segment is greater than the bandwidth orthogonal to the associated road segment. The directionalized process noise constrains the track movement to be along the desired track segment.

Pseudo-Measurements

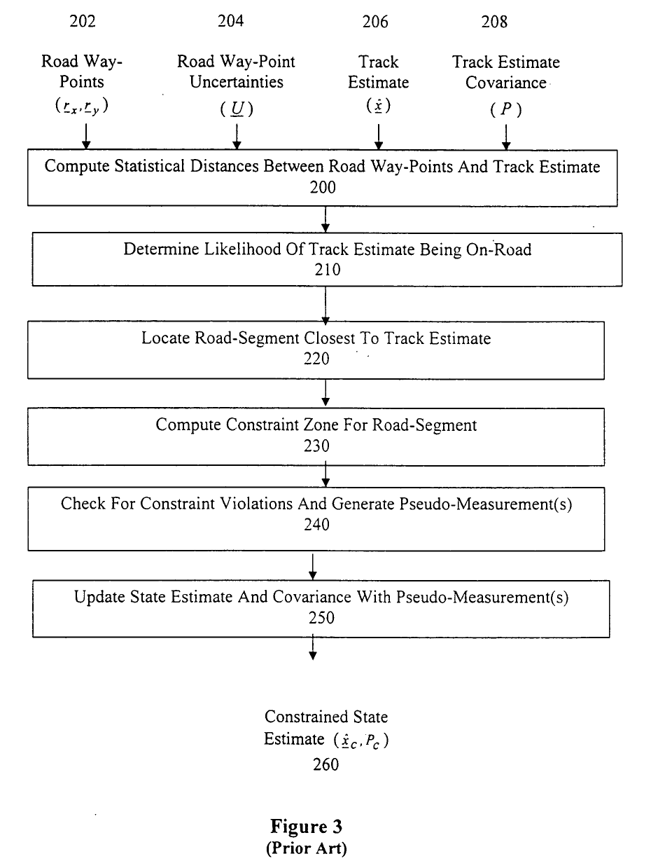

“Pseudo-measurements” is a method for performing constrained tracking which pre-defines a constraint zone and allows the estimator to freely operate within the boundaries of the constraint zone. Once the constraint zone becomes violated, however, a pseudo-measurement is generated and applied to the estimator. The magnitude and uncertainty of the pseudo-measurement are selected such that the corrected state estimate is placed on the constraint it violated, thus removing the initial violation. The use of pseudo-measurements allows the constraint information to be introduced using the normal filtering action of an estimator, and, as a result, modifies both the conditional mean and error covariance of the state estimate in a pseudo-consistent manner. A flow diagram for the pseudo-measurements method is provided in FIG. 3.

The algorithm descriptions corresponding to each element in FIG. 3 are provided below.
Compute Statistical Distances Between Road Way-Points and Track Estimate 200.

$$\begin{matrix}{D}_{i} = {{v}_{i}}^{′} {S}_{i}^{- 1} {v}_{i} \\ \text{for} i = 1 , 2 , … , N \\ \underline{\text{where}} ∷ N = \text{number of road way-points} \\ {v}_{i} = [ \begin{matrix}{rx}_{i} - \hat{x} \\ {ry}_{i} - \hat{y}\end{matrix} ] \\ {S}_{i} = [ {HPH}^{′} + {U}_{i} ] \\ H = observation matrix\end{matrix}$$

The track-to-road processing computes the normalized distance parameters between each road way-point and the desired track. Determine Likelihood Of Track Estimate Being On-Road 210:
Dₘᵢₙ_{₁}<χ₂²
Dₘᵢₙ_{₂}<χ₂²
where:
   Dₘᵢₙ_{₁}=first minimum statistical distance
   Dₘᵢₙ_{₂}=second minimum statistical distance
   χ₂²=chi-square threshold for two degrees of freedom

A road segment is defined based upon the two closest road way-points to the desired track. The next step defines the road segment based upon minimum distance parameters. The processing commences as follows:

Locate Road-Segment Closest to Track Estimate 220:
Rx₁=r_{x Dmin}_{₁}
Ry₁=r_{yDmin}_{₁}
Rx₂=r_{xDmin}_{₂}
Ry₂=r_{yDmin}_{₂}
where:
   Rx₁, Ry₁=way-point corresponding to first minimum statistical distance.
   Rx₂, Ry₂=way-point corresponding to second minimum statistical distance.

The next step is to Compute Constraint Zone For Road-Segment 230:
czₘᵢₙ_{ₓ}=min[Rx₁, Rx₂]−σ_{cz}
czₘᵢₙ_{_{y}}=min[Ry₁, Ry₂]−σ_{cz}
czₘₐₓ_{ₓ}=max[Rx₁, Rx₂]+σ_{cz}
czₘₐₓ_{_{y}}=max[Ry₁,Ry₂]+σ_{cz}
where:
   czₘᵢₙ_{ₓ}=constraint zone x-axis minimum constraint
   czₘᵢₙ_{_{y}}=constraint zone y-axis minimum constraint
czₘₐₓ_{ₓ}=constraint zone x-axis maximum constraint
czₘₐₓ_{_{y}}=constraint zone y-axis maximum constraint
σ_{cz}=constraint zone size parameter

Check For Constraint Violations and Generate Pseudo-Measurement(s) 240:

$$\begin{matrix}{z}_{pm} = {cz}_{{nv}_{x , y}} \\ {R}_{pm} = C \cdot {P}_{v} \cdot {C}^{′} \cdot [ \frac{{cz}_{{nv}_{x , y}} - C \cdot {\underline{\hat{x}}}_{v}}{{cz}_{{v}_{x , y}} - C \cdot {\underline{\hat{x}}}_{v}} ]\end{matrix}$$

where:
   zₚₘ=pseudo-measurement (set to non-violated constraint)
   Rₚₘ=pseudo-measurement covariance
   C=pseudo-measurement observation matrix
   \hat{x}ᵥ=state estimate violating constraint
   Pᵥ=state estimate covariance violating constraint
   czᵥ_{_{x,y}}=violated constraint
   czₙᵥ_{_{x,y}}=non-violated constraint

Update State Estimate and Covariance with Pseudo-Measurement(s) 250 and Generate the Constrained State Estimate 260:
\hat{x}_{c}=\hat{x}ᵥ+[P·C′·(C·P·C′+Rₚₘ)⁻¹]·[zₚₘ−C·\hat{x}ᵥ]
P_{c}=Pᵥ−[P·C′·(C·P·C′+Rₚₘ)⁻¹]·C·Pᵥ
Regional Measurements

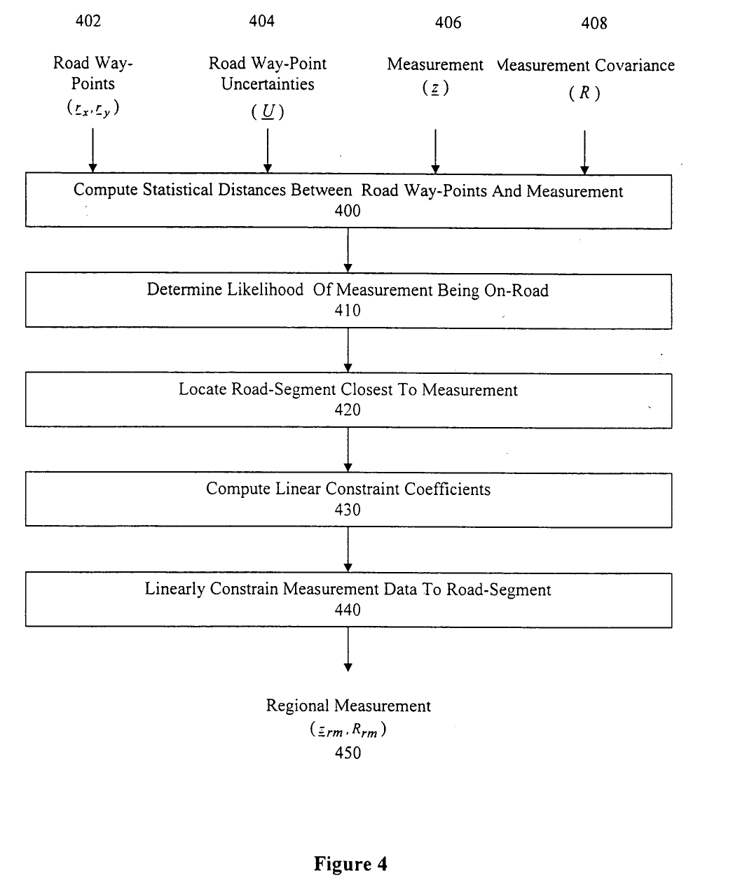

“Regional measurements” is a method of performing constrained tracking which linearly constrains the open-loop measurement data prior to being applied to the estimator. This method of performing constrained tracking allows the closed-loop nature of the estimator to remain unaltered while driving the performance and robustness of the estimator solely based upon the accuracy of the measurement and measurement covariance information. A flow diagram for the “regional-measurements” method is provided in FIG. 4.

The depicted embodiment of the present invention in FIG. 4 describes a measurement-constrained approach to achieving high-precision tracking as opposed to the typical track-constrained approaches. The typical constrained tracking approaches, such as directional process noise and pseudo-measurements use a-priori road information that is collected and used to constrain the state estimates of a tracking filter when there is a ‘high’ likelihood that a given vehicle is traveling along some known path. The typical track-constrained approach has difficulty in accurately updating the estimator's covariance to reflect the level of constraint applied to the state estimates. When the state estimate of a tracking filter is constrained to a-priori road information, the covariance describing the improved uncertainty is not consistent with the level of constraint applied to the state estimate data. As a result, adverse effects may be induced into the closed-loop nature of the estimator resulting in degraded tracking performance when large spatial and/or dynamic constraints are required.

Thus, a better methodology of performing constrained tracking is to constrain the open-loop measurements supplied to the estimator. By constraining the open-loop measurement data prior to being applied to the estimator, the closed-loop nature of the estimator remains unaltered and the performance and robustness of the estimator is solely driven based upon the accuracy of the measurement and measurement covariance information.

The algorithm descriptions corresponding to each element in FIG. 4 are provided herein. Certain information is used for the processing, namely road-way points 402 which as already explained are predetermined position points that can be static or dynamic. The road way-point uncertainties 404 relates to the level of accuracy associated with the road way point position point. The Measurement 406 refers to the position estimate. And, track measurement covariance 408 relates to the amount of uncertainty for the measurement such as the triangulation uncertainty using bearing lines from the sensors.

The Processing Commences with Computing Statistical Distances Between Road Way-Points and Measurement 400:

$$\begin{matrix}{D}_{i} = {v}_{i}^{′} {S}_{i}^{- 1} {v}_{i} \\ for i = 1 , 2 … , N\end{matrix}$$

$$\begin{matrix}where ∷ N = \text{number of road way-points} \\ {v}_{i} = [ \begin{matrix}{rx}_{i} - {z}_{x} \\ {ry}_{i} - {z}_{y}\end{matrix} ] \\ {S}_{i} = [ R + {U}_{i} ]\end{matrix}$$

The measurement processing computes the normalized distance parameters between the road way-point and the desired measurement. Determine Likelihood Of Track Estimate Being On-Road 410:
Dₘᵢₙ_{₁}<χ₂²
Dₘᵢₙ_{₂}<χ₂²
where:
   Dₘᵢₙ_{₁}=first minimum statistical distance
   Dₘᵢₙ_{₂}=second minimum statistical distance
χ₂²=chi-square threshold for two degrees of freedom

A road segment is defined based upon the two closest road way-points to the desired measurement. The next step defines the road segment based upon minimum distance parameters. The processing commences as follows:

Locate Road-Segment Closest to Measurement 420:
Rx₁=r_{xDmin}_{₁}
Ry₁=r_{yDmin}_{₁}
Rx₂=r_{xDmin}_{₂}
Ry₂=t_{yDmin}_{₂}
where:
   Rx₁, Ry₁=way-point corresponding to first minimum statistical distance.
   Rx₂, Ry₂=way-point corresponding to second minimum statistical distance.
      Compute Linear Constraint Coefficients 430:
      α₁=1.0−α₂
      α₂=0.5·(Dₘᵢₙ_{₁}/Dₘᵢₙ_{₂})
      Linearly Constrain Measurement Data to Road-Segment 440 and Compute the Regional Measurement 450:
      zᵣₘ_{_{z}}=α₁·RX₁+α₂·RX₂
      zᵣₘ_{_{y}}=α₁·RY₁+α₂·RY₂
      Rᵣₘ=R·(Dₘᵢₙ_{₁}/Dₘᵢₙ_{₂})
      Simulation Results

All performance results provided in this work are based upon actual field-test data. For the simulation data set evaluated in this work, all methods for constrained tracking produced identical track initiation and track duration results. Consequently, the primary metric of interest considered for this work was track accuracy.

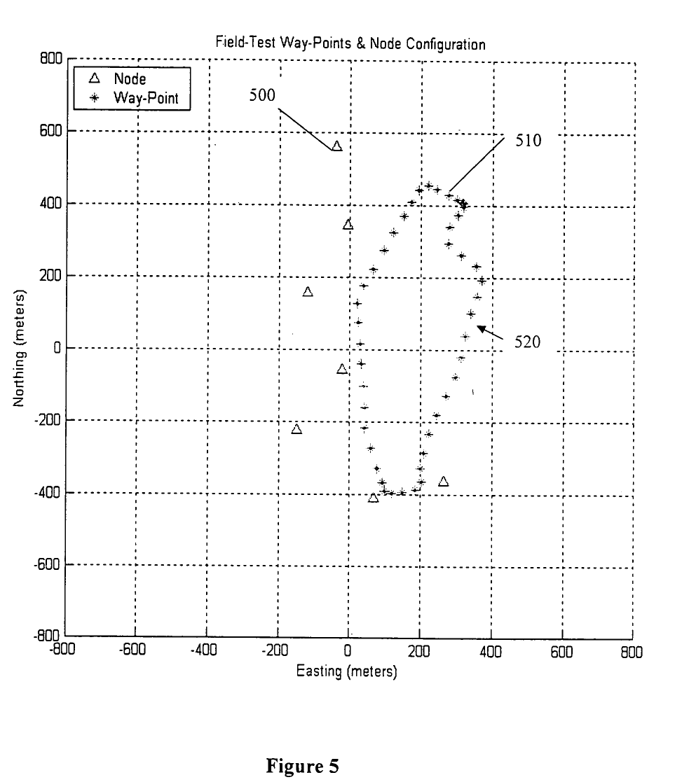

The target path and node configuration used for the field test are illustrated in FIG. 5. The true target starts at “12:00” and traverses counter-clockwise one complete revolution. The nodes 500 represent the array of deployed sensors. The way-points 510 are along the target path and depict pre-determined measurement points. The way-points can be static or dynamically allocated if the region has been mapped. The target path is generally processed having a bandwidth or range that can be dynamically calculated based on certain parameters such as noise or set to a fixed value. The axes of the graph represent Northing and Easting in meters for two-dimensional tracking.

The parameters utilized for each method of constrained tracking are provided herein, namely:

Directional Process Noise:

χ₂²=3.0
σₒ=0.0 meters
σₐ=100.0 meters
   Pseudo-Measurements:
χ₂²=3.0
σ_{cz}=1.0 meter
   Regional Measurements:
χ₂²=3.0

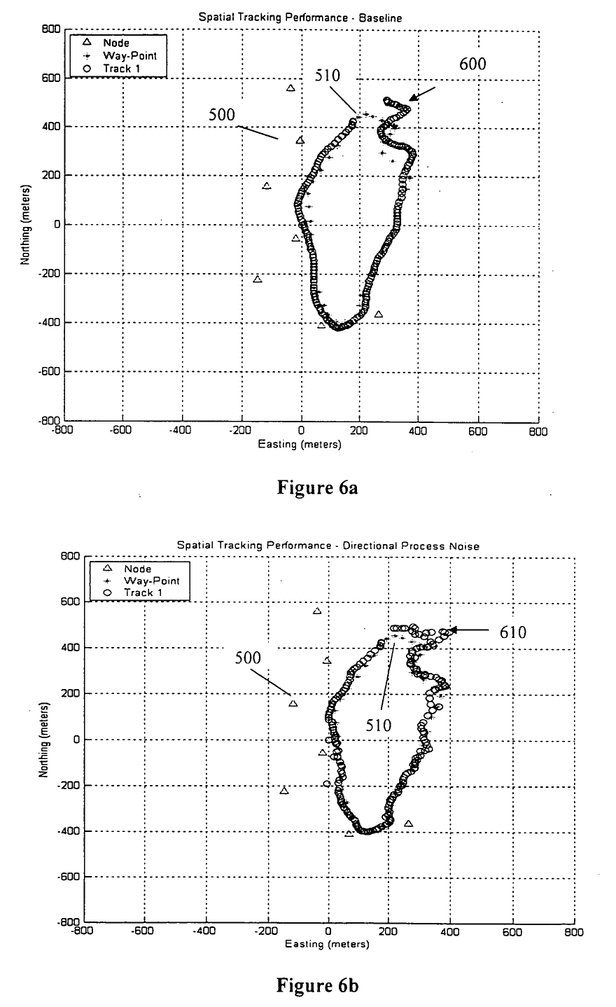

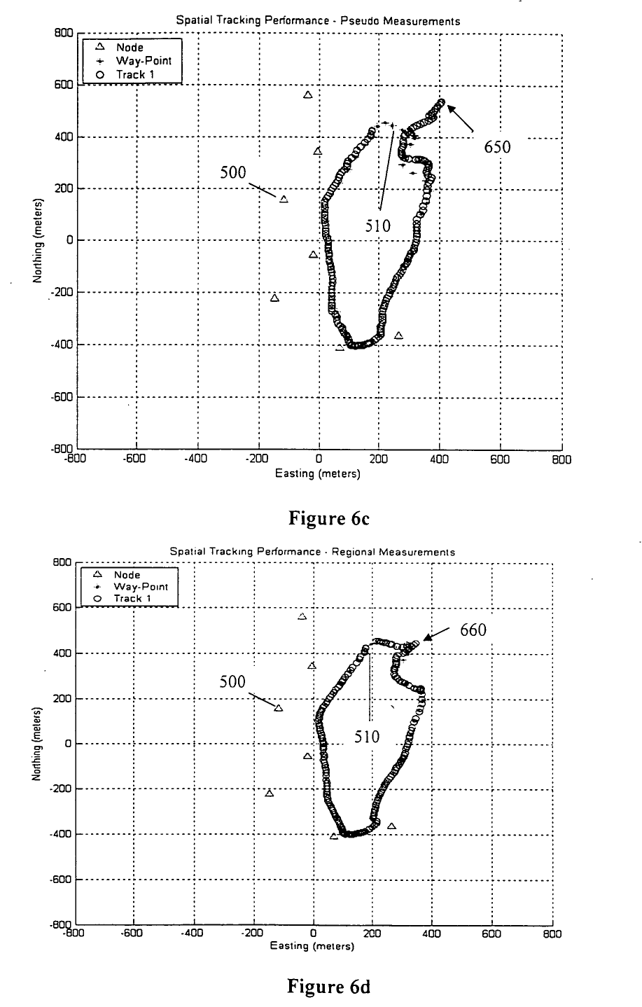

FIGS. 6a-6d illustrates the spatial tracking performance for each method of constrained tracking. FIG. 6a is the baseline for the spatial tracking performance and as noted, the baseline track 600 travels about the target path of way-points 510 and deviating at certain points during the counter-clockwise path. This baseline track 600 represents the tracking performance without any form of constrained tracking applied and is presented for comparison purposes.

FIG. 6b represents the test data for the directional process noise method. The track 610 for the directional process noise processing generally follows the way-points 510 however it deviates from the target path on several instances. As noted, there is considerable ‘noise’ or jitter on the estimates and the track 610 barely makes the turn at the top right.

FIG. 6c represents the test data for the pseudo measurements scheme. The track 650 for the pseudo measurement processing generally follows the path outlined by the way-points 510 deviating as indicated. While the pseudo measurement track 650 has less jitter, it is unable to make the turn at the top right.

FIG. 6d shows the test data for the regional measurements according to one embodiment of the present invention. The track 660 for the regional measurement processing closely follows the way-point path and the waypoints 510 are essentially covered throughout the path. This visually demonstrates that the regional measurements methodology provides the closest tracking as there is no jitter and it does make the turn at the top right.

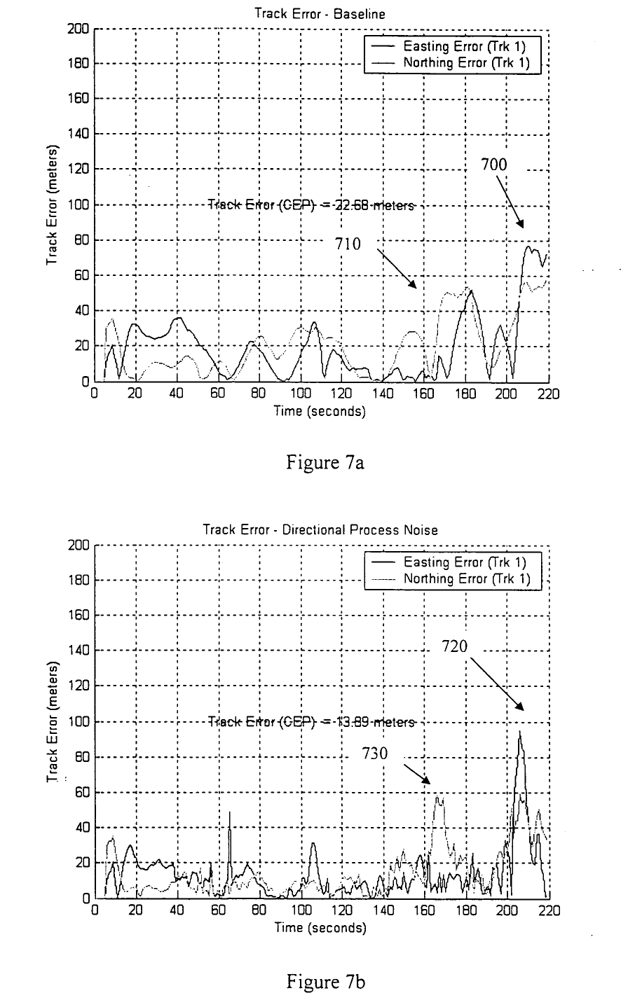

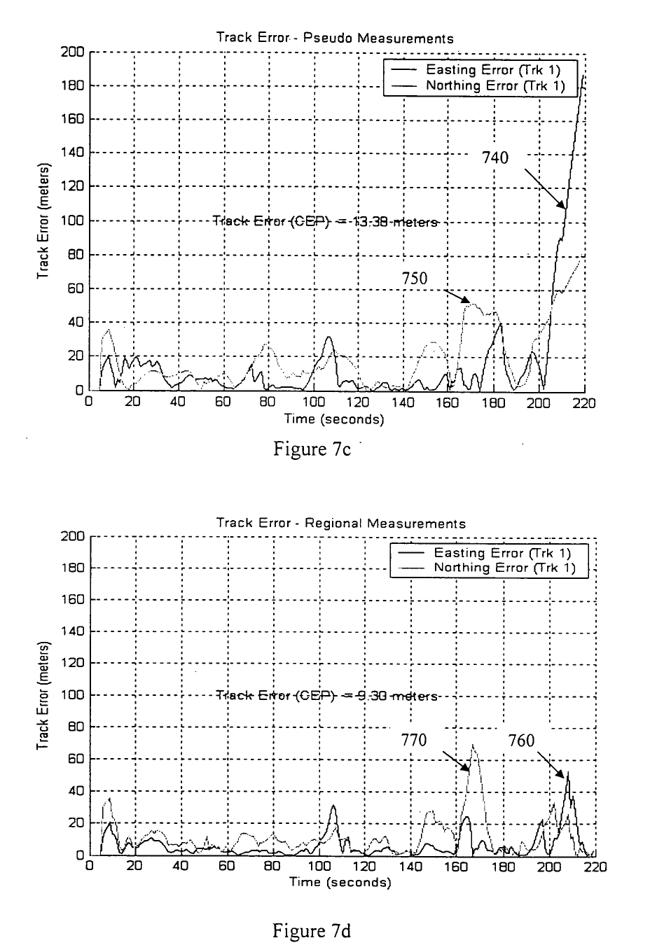

FIGS. 7a-7d illustrates the track error with respect to truth for each method of constrained tracking.

FIG. 7a shows the track error for the baseline testing. The Circular Error Probability (CEP) for the baseline test is 22.68 meters. The Easting error 700 and Northing error 710 depict the tracking error as measured in meters over the time interval (seconds) for the counter-clockwise travel of the target along the path. The baseline track shows a larger error especially at the turn at approximately 180-200 seconds.

FIG. 7b shows the track error for the directional process noise testing. The Circular Error Probability for directional process noise test is 13.89 meters. The Easting error 720 and Northing error 730 depict the tracking error as measured in meters over the time interval (seconds) for the counter-clockwise travel of the target along the path. As shown, there is considerable noise and a large error especially at the turn.

FIG. 7c shows the track error for the pseudo measurements testing. The Circular Error Probability for the pseudo measurements test is 13.38 meters. The Easting error 740 and Northing error 750 depict the tracking error as measured in meters over the time interval (seconds) for the counter-clockwise travel of the target along the path. While the pseudo measurement track has less noise, it does possess significant error at the turn.

FIG. 7d shows the track error for the regional measurements testing. The Circular Error Probability for the regional measurements test is 9.30 meters. The Easting error 760 and Northing error 770 depict the tracking error as measured in meters over the time interval (seconds) for the counter-clockwise travel of the target along the path. As shown, the regional measurement scheme has less noise and minimal error at the turn.

Thus, FIGS. 6a-d and 7a-d graphically depict that the regional measurements method of constrained tracking provides the best tracking accuracy along with the most amount of responsiveness and robustness.

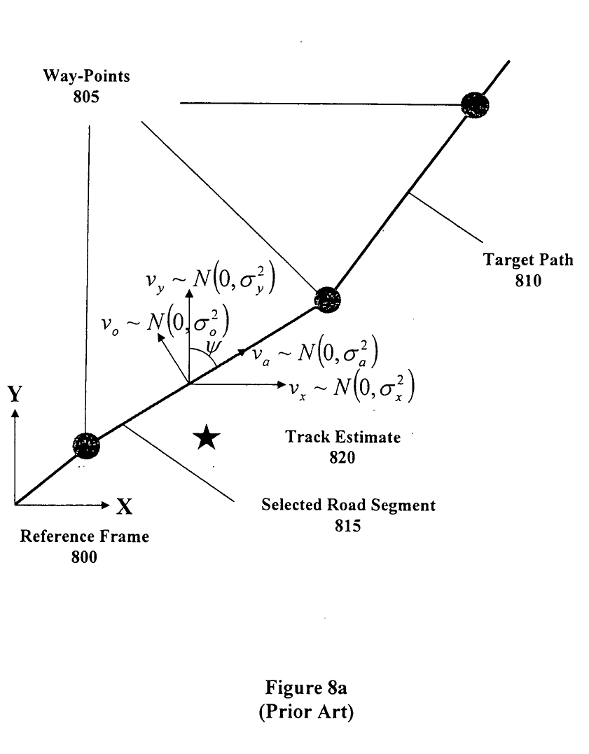

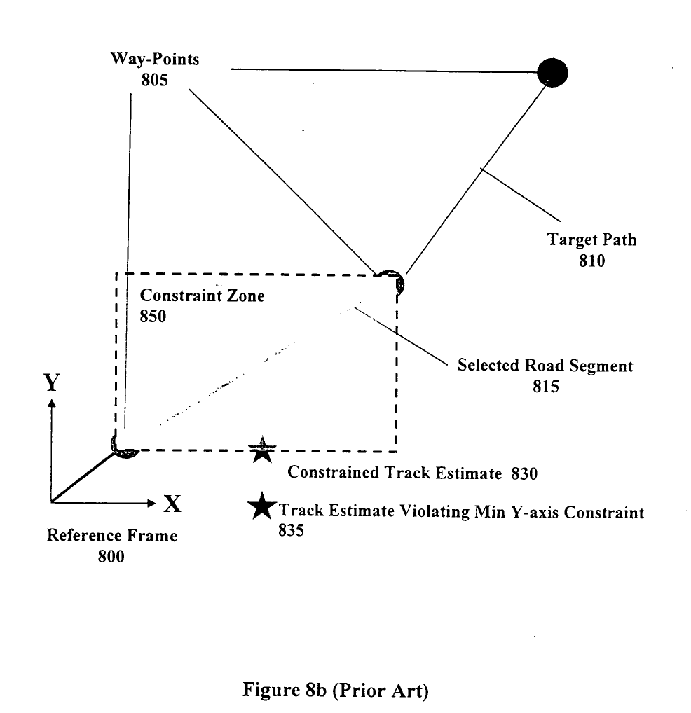

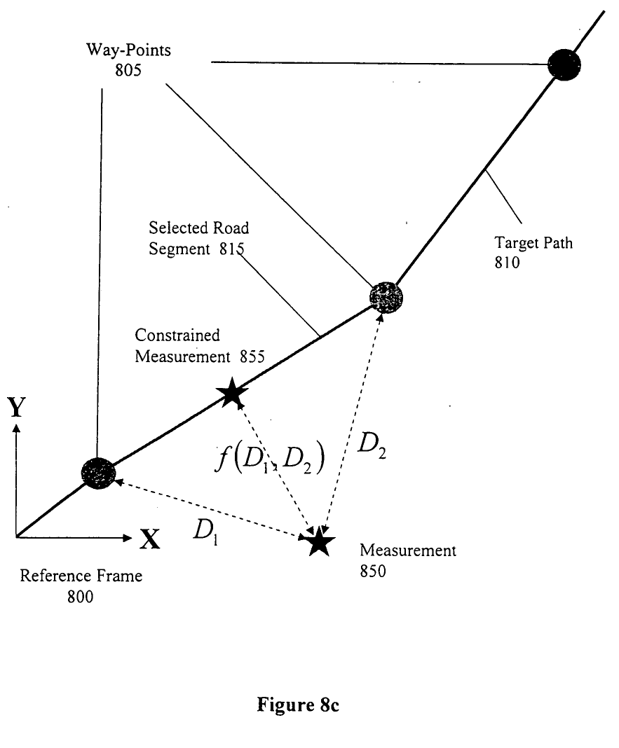

Referring to FIG. 8a, the processing according to directional process noise is graphically illustrated. As described herein, the directional process noise allows target motion along the selected road segment and restricts target motion orthogonal to the selected road segment by controlling the estimator's process noise model. The estimator's process noise is modified by computing the angle of the selected road segment, ψ, with respect to the reference frame and rotating the road segment uncertainty parameters, σₐ² and σₒ², into the estimators process model, σₓ² and σ_{y}². By selecting σₐ²>>σₒ², the directional process noise technique provides more uncertainty (bandwidth) along the road segment and less uncertainty (bandwidth) orthogonal to the road segment resulting in constrained target motion relative to the selected road segment.

The reference frame 800 establishes the X/Y coordinate system for processing and can be absolute or relative. The way-points 805 are shown along the target path 810. The selected road segment 815 represents the section between two waypoints 800 for processing the target estimate 820.

FIG. 8b shows the processing according to pseudo-measurements scheme. As described herein, the pseudo-measurements allow the estimator to freely operate within boundaries of a predefined constraint zone. Once the constraint zone is violated or breached, a pseudo-measurement is generated and applied to the estimator. The magnitude and uncertainty of the pseudo-measurement is selected such that the constrained state estimate is placed on a violated constraint thereby removing the initial violation. The pseudo-measurement is applied using normal filtering action of the estimator and modifies both conditional mean and covariance in a pseudo-consistent manner.

The reference frame 800 establishes the X/Y coordinate system for processing and can be absolute or relative. The way-points 805 are shown along the target path 810. The selected road segment 815 represents the section between two waypoints 800. The constraint zone 850 represents the bounded-region wherein the estimator operates without any constraints. When there is a track estimate violation 835 that is outside of the constraint zone 850, the pseudo-measurement processing is performed and applied to the estimator thereby generating a constrained track estimate 830.

Referring to FIG. 8c, the regional measurement system is graphically depicted. The regional measurements linearly projects open-loop measurement data onto the selected road segment prior to being applied to the estimator. The closed-loop nature of the estimator remains unchanged and the performance and robust nature of the estimator is driven by the accuracy of measurement and measurement covariance information.

The reference frame 800 establishes the X/Y coordinate system for processing and can be absolute or relative. The way-points 805 are shown along the target path 810. The selected road segment 815 represents the section between two waypoints 805 as detailed herein.

As described here, the sensor data is used to derive the Measurement 850. The Statistical Distances Between Road Way-Points And, Measurement 850 is computed for the two closest way-points 805 according to the formula below, and the resultant statistical distance is shown as D₁ and D₂:

$$\begin{matrix}{D}_{i} = {v}_{i}^{′} {S}_{i}^{- 1} {v}_{i} \\ for i = 1 , 2 … , N \\ where : N = \text{number of road way-points} \\ {v}_{i} = [ \begin{matrix}{rx}_{i} - {z}_{x} \\ {ry}_{i} - {z}_{y}\end{matrix} ] \\ {S}_{i} = [ R + {U}_{i} ]\end{matrix}$$

The measurement processing then determines the likelihood that the Measurement 850 is on-road or off-road by applying a chi-square threshold to D1 and D2.
Dₘᵢₙ_{₁}<χ₂²
Dₘᵢₙ_{₂}<χ₂²
where:
   Dₘᵢₙ_{₁}=first minimum statistical distance
   Dₘᵢₙ_{₂}=second minimum statistical distance
χ₂²=chi-square threshold for two degrees of freedom

The constrained tracking is only pursued if D1 and D2 are within the chi-square threshold bounds, otherwise the measurement data is processed without constraints.

A road segment 815 is then defined based upon the two closest road way-points 805 to the measurement 850. The road segment 815 is based upon minimum distance parameters, and the processing commences as follows:

Locate Road-Segment Closest to Measurement:
Rx₁=r_{xDmin}_{₁}
Rx₂=r_{xDmin}_{₁}
Ry₂=r_{yDmin}_{₂}
Ry₂=r_{yDmin}_{₂}
where:
   Rx₁, Ry₁=way-point corresponding to first minimum statistical distance.
   Rx₂, Ry₂=way-point corresponding to second minimum statistical distance.

The processing continues with computing the linear constraint coefficients to be used for the constrained measurement. The coefficients are derived as follows:
α₂=0.5·(Dₘᵢₙ_{₁}/Dₘᵢₙ_{₂})
α₁=1.0−α₂

Once the linear coefficients have been processed, the next step is to linearly constrain the Measurement 850 To Road-Segment 815 and compute the regional constrained measurement 855:
zᵣₘ_{ₓ}=α₁·RX₁+·α₂·RX₂
zᵣₘ_{_{y}}=α₁·RY₁+α₂·RY₂
Rᵣₘ^{=R}·(Dₘᵢₙ_{₁}/Dₘᵢₙ_{₂})

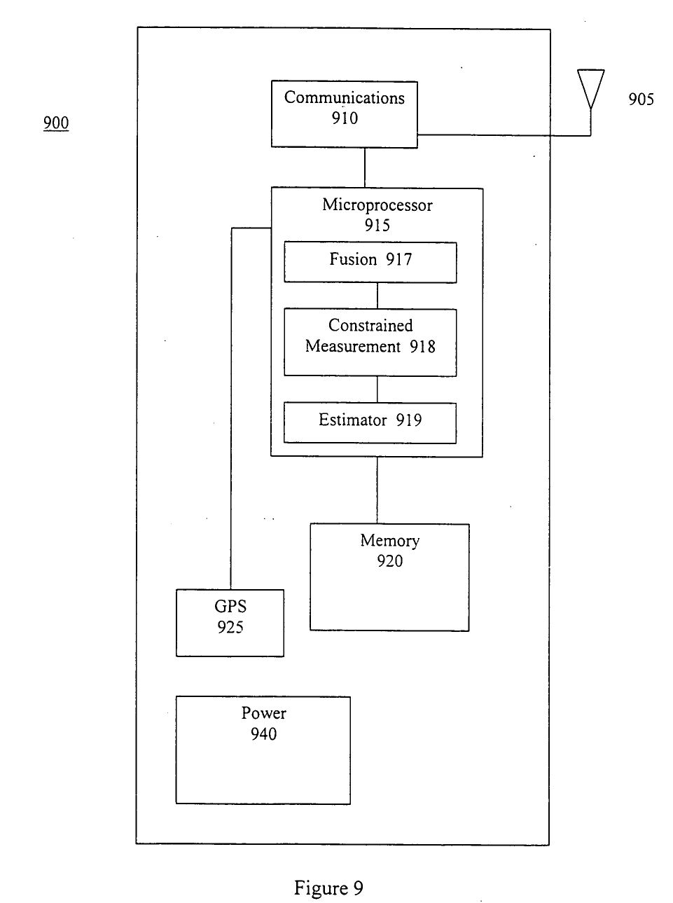

FIG. 9 illustrates a simplified embodiment of central command and control 900. There is an antenna 905 and communications section 910 that is responsible for receiving and transmitting data and instructions to and from at least one sensor (not shown). The data may also be transmitted to other control centers in processed form or as raw data.

The data from the one or more sensors (not shown) is received by the antenna 905 and processed by the communications section 910 to provide the digital data to the processing section 915. It is common for the data to be amplified and filtered prior to processing by the microcomputer 915. The processing within the microprocessor 915 commences as described herein and reads/stores data to the memory section 910 as needed.

The processing section 915 includes a fusing section 917, constrained measurement processing section 918 and the estimator 919. The regional measurements processing accepts target localization (position) information. If target localization information is not directly available, as in a bearing-only system, then some form of data fusion 917 is required to transform the available information into target localization (position) information. The regional measurement processing constrains the provided target localization information 918 and sends the constrained result to an optimal tracking filter or estimator 919, for additional filtering and reduction in target location uncertainty. The filter types include any of the constant gain or variable gain filter including Kalman filters.

According to one embodiment of the present invention, the constrained open-loop measurement data from the fusing section 917 is applied by the constrained measurement section 918 before the data is processed by the tracking filter or estimator 919. The tracking filter or estimator 919 accepts constrained position and uncertainty data provided by the regional measurement processing which is used to compute a weighting factor depending upon the uncertainty level of the constrained regional measurement. For example, a noisy or higher degree of uncertainty for a given linearly constrained position will lower the weighting factor utilized by the filter. The improved position data from the estimator 919 is used for estimating future positions in order to provide an updated position measurement.

The system 900 can employ a GPS unit 925 which not only provides the geographic location data but also a precision clock.

Power unit 940 provides the necessary power to the components of the control unit 900. The power can be external AC source from a power line or generator or from various other power sources known to those skilled in the art such as batteries and solar energy.

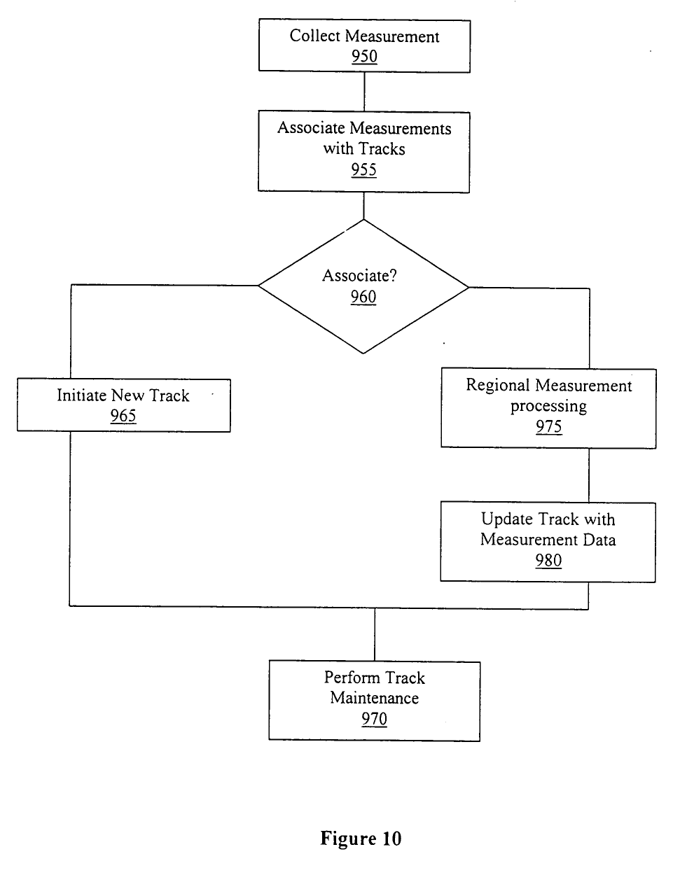

The system gateway processing in one embodiment can be expressed as illustrated in FIG. 10, wherein the gateway or central processing unit receives sensor measurement data 950 from the various sensors and/or sub-system gateways. As described herein, the sensor data can be bearing lines from at least one sensor that is transmitted directly to the central processing unit or to retransmitted from another gateway device. The collected measurements are processed to locate one or more target position using techniques such as triangulation schemes. The target measurements are then processed as described herein to associate the target location measurements to the tracks 955. If the target measurements associate with one or more tracks 960, then regional measurement processing is applied 975 as further detailed in the accompanying description of FIG. 4 and the constrained measurement result is sent to the tracking filter or estimator for additional filtering and reduced uncertainty in target location 980.

If the target measurements do not associate with one or more tracks 960, then the non-associated measurement data is used to initiate new target tracks 965. Once all measurements have been used to update existing tracks 980 or initiate new tracks 965, then standard track maintenance routines 970 such as track combination, track termination and track propagation are performed for future processing. Track termination refers to the processes associated with the merger or cancellation of certain tracks. The track propagation refers to a number of processes and includes forwarding the optimized position measurements to predict the next expected positions. It should be readily apparent that having knowledge of positions and time can be used to process velocity (change in distance divided by change in time) and even acceleration (change in velocity divided by change in time).

For comparison purposes, the constrained processing under the directional process noise is generally performed when performing track maintenance. Likewise, the pseudo-measurement technique is typically incorporated into the system when updating the track with measurement data.

In one working embodiment, the present invention is implemented with a gateway that communicates with a plurality of UGS devices. The technology and variations of UGS are well known to those in the art and may have are one or more sensing units coupled to a UGS microprocessor, a memory section, a GPS unit, and a communications section. A power supply such as a battery, solar or other power source provide the necessary power for the UGS. The UGS sensing units can be any of the sensor types known in the art such as optical, magnetic, seismic, and acoustic as well as any combination thereof. There may be analog-digital processing for analog sensors in order to place the data in a format usable by the rest of the system. The UGS microprocessor can control the functionality of the unit and transmit data via the communications section to the gateway. There may be a number of gateway units deployed in the region that gathers data from a number of UGS units and re-transmits the data to a central gateway or controlling center. In this fashion the gateways act as repeaters that relay sensor data as the sensors generally have low power capabilities.

The processing section that processes data from the UGS sensors, such as bearing lines, calculates or triangulates the target position. The position measurement is analyzed to determine if it is a reasonable target location in order to assess whether to constrain tracking or allow for non-constrained measurements. The bounds of the target path are generally normalized statistical measurements although various road bounds can be used, wherein the system assesses whether the processed position is close enough to the road to be constrained. If the constrained tracking is employed, the regional measurement linearly projects open-loop measurement data onto selected road segments prior to being applied to the estimator. The closed loop nature of the estimator remains unchanged. If the tracking measurement is ‘off-road’, the processing is unconstrained and processed without the constraints.

As is known to those skilled in the art, Kalman filtering is basically described as Xₖ₊₁=Xₖ+G(Xₖ−m). It is generally understood that directional process noise techniques substantially rely on the Kalman filter. Likewise, pseudo-measurements also tend to be heavily dependent on Kalman filtering. However, the regional measurement system of the present invention is not bound to Kalman filtering and other filtering types are within the scope of the invention. Any of the variable gain or constant gain filters may be employed with the present invention.

The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

What is claimed is:

1. A method for tracking mobile objects along a target path, comprising:
identifying a plurality of way-points along the target path;
processing a position measurement of at least one object;
computing a distance parameter between said position measurement and at least two of said way-points;
defining a road segment between two of said way points closest to said position measurement; and
linearly constraining said measurement position to said road segment and computing a regional measurement.

2. The method according to claim 1, further comprising determining a likelihood that said position measurement is within a range of said target path, and computing said position measurement without said linearly constraining if said position measurement is outside said range.

3. The method according to claim 2, wherein said range is a chi-square threshold.

4. The method according to claim 1, wherein said way-points are position coordinates are selected from at least one of the group consisting of: pre-determined geographical positions and dynamically derived geographical positions.

5. The method according to claim 1, wherein said position measurement is derived from triangulating a set of bearing lines from at least two sensors that detects said object.

6. The method according to claim 1, wherein said computing employs at least one uncertainty variable, said uncertainty variable selected from at least one of the group consisting of: a set of road way-point uncertainties and a measurement covariance.

7. The method according to claim 1, further comprising applying said regional measurement to a tracking filter.

8. The method according to claim 7, wherein said tracking filter is selected from at least one of the group consisting of: a variable gain filter and a constant gain filter.

9. The method according to claim 1, wherein said processing said position measurement is transmitted from a repeater.

10. An apparatus for tracking at least one mobile target, comprising:
a communications section;
a memory device; and
a microprocessor coupled to said communications section and said memory device,
wherein said microprocessor comprises a constrained measurement unit, and an estimator, wherein a target position measurement is linearly constrained by said constrained measurement unit prior to processing by said estimator.

11. The apparatus according to claim 10, wherein said microprocessor further comprises a fusion section that processes said target position measurement from a set of sensor measurements received by said communications section.

12. The apparatus according to claim 10, further comprising a global positioning system coupled to said microprocessor.

13. The apparatus according to claim 10, wherein said estimator employs a filter selected from at least one of the group consisting of: a variable gain filter and a constant gain filter.

14. A system for tracking at least one mobile target in a region along a target path having way-points, comprising:
a plurality of sensors deployed in the region, wherein said sensors detect said mobile target;
a first processing section that receives target data from said sensors and processes target localization information;
a second processing section wherein said target localization information is linearly constrained and generates a regional measurement; and
a third processing section that filters said regional measurement and generates a filtered target position.

15. The system according to claim 14, wherein said target data from said sensors is at least two bearing lines and said target localization information is processed using triangulation from said bearing lines.

16. The system according to claim 14, wherein said filtered target position updates a target track.

17. The system according to claim 14, wherein said third processing section employs a tracking filter selected from at least one of the group consisting of: a variable gain filter and a constant gain filter.

18. The system according to claim 14, wherein said filtered target position is communicated to a central processing center.

19. The system according to claim 14, wherein said target path has a threshold bounds and if said target localization information is outside said threshold bounds, said target localization information is not linearly constrained and said target localization information establishes a non-constrained target position.

20. The system according to claim 14, wherein said first processing section receives target data from at least one repeater unit that communicates with said sensors.
